(19) United States
(12) Patent Application Publication
(10) Pub. No.: US 2018/0315024 A1
(43) Pub. Date: Nov. 1, 2018

(54) Systems and Methods Enabling Secure Transactions from Terminal Window

(71) Applicant: Zeit, Inc., San Francisco, CA (US)

(72) Inventors: Guillermo Rauch, San Francisco, CA (US); Matheus Fernandez Vieira, Sao Paulo (BR); Tony Kovanen, Espoo (FI)

(21) Appl. No.: 15/967,020

(22) Filed: Apr. 30, 2018

Related U.S. Application Data
(60) Provisional application No. 62/492,116, filed on Apr. 29, 2017.

(51) Int. Cl. G06Q 20/02; H04L 29/12; G06Q 30/06

(52) U.S. Cl. CPC G06Q 20/027; H04L 61/3005; H04L 61/3025; G06Q 30/0613; H04L 61/302

(57) ABSTRACT

Systems and methods for enabling a secure transaction from within a primary interface of a computing device includes receiving a user input indicating a domain name of interest in a syntax of the primary interface, transmitting a first command to a server to cause the server to determine an availability of the domain name, receiving an indication of the availability of the domain name from the server, generating, in response to a determination that the domain name is available, a user prompt to query whether the domain name should be purchased in the syntax of the primary interface, receiving a user input indicating that the domain name should be purchased in the syntax of the primary interface, and transmitting a second command to the server to cause the server to purchase the domain name.

### CROSS-REFERENCE TO RELATED APPLICATION

This application claims the benefit of U.S. Provisional Patent Application No. 62/492,116, filed Apr. 29, 2017, the entire disclosure of which is incorporated herein by reference.

### TECHNICAL FIELD

The present disclosure relates to systems and methods enabling users to execute secure transactions with third-party providers from within a primary interface of a computing device.

### BACKGROUND

Software developers solve non-trivial problems and operate best on schedules that include extended periods of uninterrupted time for thought and creation, effectively allowing them to “get in the zone.” Consequently, anything that interrupts a software developer's state of concentration can be detrimental. Unfortunately, tasks such as acquiring domain names, acquiring Secure Sockets Layer (SSL)/Extended Validation (EV) certificates, automatically renewing original server certificates, upgrading server capacity, and others that are necessary for testing, deploying, or scaling code often involve significant interruptions to the workflow of software developers. These tasks typically require software developers to switch between multiple tools and websites to execute on financial transactions.

One existing tool, SSLMate, provides a terminal command interface for purchasing SSL certificates for encrypted linkages between web servers and Internet browsers. While SSLMate allows the user to make an initial terminal command to initiate the purchase, the user is still required to exit the terminal to (1) go to their email client and (2) then go to RapidSSL.com, where the user must review and approve all of the purchase details, and finally (3) return to the terminal, where the user must run a final command to confirm receipt of the certificate.

### SUMMARY

The present application discloses one or more of the features recited in the appended claims and/or the following features which, alone or in any combination, may comprise patentable subject matter:

According to the present disclosure, a method for enabling a secure transaction from within a primary interface of a computing device may comprise receiving, by the primary interface, a user input from a user indicating a domain name of interest in a syntax of the primary interface; transmitting, by the computing device, a first command to a server to cause the server to determine an availability of the domain name; receiving, by the computing device, an indication of the availability of the domain name from the server; generating, by the primary interface, in response to an indication from the server that the domain name is available, a user prompt to query whether the domain name should be purchased in the syntax of the primary interface; receiving, by the primary interface, a user input indicating that the domain name should be purchased in the syntax of the primary interface; and transmitting, by the computing device, a second command to the server to cause the server to purchase the domain name.

In some embodiments, the primary interface may be a terminal window of the computing device.

In some embodiments, transmitting the first and/or second commands to the server may cause the server to determine whether the user input is associated with an existing user account and to create, in response to a determination that the user input is not associated with an existing user account, a new user account.

In some embodiments, the method may further comprise receiving, by the computing device, an indication from the server that the new user account has been created; and generating, by the primary interface, in response to the indication from the server that the new user account has been created, a user prompt to set up a billing method which is to be used to purchase the domain name in the syntax of the primary interface.

In some embodiments, transmitting the first and/or second commands to the server may further cause the server to determine, in response to the creation of the new user account, whether the new user account belongs to an existing group having an existing billing method.

In some embodiments, the method may further comprise receiving, by the computing device, an indication from the server that the new user account does not belong to an existing group; and generating, by the primary interface, in response to the indication from the server that the new user account does not belong to an existing group, a user prompt to set up a billing method which is to be used to purchase the domain name in the syntax of the primary interface.

In some embodiments, transmitting the first and/or second commands to the server may cause the server to determine whether the user input is associated with an existing user account and to retrieve, in response to a determination that the user input is associated with an existing user account, an existing billing method that is to be used to purchase the domain name.

In some embodiments, the method may further comprise deploying an application to the domain name from the primary interface using the syntax of the primary interface.

According to another embodiment of the present disclosure, a method for enabling a secure transaction from within a primary interface of a computing device may comprise receiving, by the primary interface of the computing device, an aliasing request in a syntax of the primary interface, the aliasing request including an existing domain name and a new domain name that is to alias the existing domain name; transmitting, by the computing device, a first command to a server to cause the server to determine whether the new domain name is registered and to determine, in response to a determination that the new domain name is not registered, an availability of the new domain name; receiving, by the computing device, an indication of the availability of the new domain name from the server; generating, by the primary interface, in response to an indication from the server that the new domain name is available, a user prompt to query whether the new domain name should be purchased in the syntax of the primary interface; receiving, by the primary interface, a user input indicating that the new domain name should be purchased in the syntax of the primary interface; and transmitting, by the computing device, a second command to the server to cause the server to purchase the new domain name and to alias the existing domain name with the new domain name.

In some embodiments, the primary interface may be a terminal window of the computing device.

In some embodiments, transmitting the first and/or second commands to the server may cause the server to determine whether the user input is associated with an existing user account and to create, in response to a determination that the user input is not associated with an existing user account, a new user account.

In some embodiments, the method may further comprise receiving, by the computing device, an indication from the server that the new user account has been created; and generating, by the primary interface, in response to the indication from the server that the new user account has been created, a user prompt to set up a billing method which is to be used to purchase the domain name in the syntax of the primary interface.

In some embodiments, transmitting the first and/or second commands to the server may further cause the server to determine, in response to the creation of the new user account, whether the new user account belongs to an existing group having an existing billing method.

In some embodiments, the method may further comprise receiving, by the computing device, an indication from the server that the new user account does not belong to an existing group; and generating, by the primary interface, in response to the indication from the server that the new user account does not belong to an existing group, a user prompt to set up a billing method which is to be used to purchase the domain name in the syntax of the primary interface.

In some embodiments, transmitting the first and/or second commands to the server may cause the server to determine whether the user input is associated with an existing user account and to retrieve, in response to a determination that the user input is associated with an existing user account, an existing billing method that is to be used to purchase the domain name.

In some embodiments, the method may further comprise deploying an application to the domain name from the primary interface using the syntax of the primary interface.

According to another embodiment of the present disclosure, a computing device may comprise a primary interface configured to receive a user input indicating a domain name of interest in a syntax of the primary interface; cause the computing device to transmit a first command to a server to cause the server to determine an availability of the domain name; receive an indication of the availability of the domain name from the server; generate, in response to a determination that the domain name is available, a user prompt to query whether the domain name should be purchased in the syntax of the primary interface; receive a user input indicating that the domain name should be purchased in the syntax of the primary interface; and cause the computing device to transmit a second command to the server to cause the server to purchase the domain name.

In some embodiments, the primary interface may be a terminal window of the computing device.

In some embodiments, the primary interface may be further configured to deploy an application to the domain name from the primary interface using the syntax of the primary interface.

In some embodiments, the primary interface may be further configured to receive a user input indicating a billing method to be used to purchase the domain name and to cause the computing device to transmit the billing method to the server.

In some embodiments, the second command may cause the server to purchase the domain name using the billing method.

Additional features, which alone or in combination with any other feature(s), including those listed above and those listed in the claims, may comprise patentable subject matter and will become apparent to those skilled in the art upon consideration of the following detailed description of illustrative embodiments exemplifying the best mode of carrying out the invention as presently perceived.

### BRIEF DESCRIPTION OF THE DRAWINGS

The concepts described in the present disclosure are illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. The detailed description particularly refers to the accompanying figures in which:

FIG. 1 is a simplified diagram illustrating a system enabling users to execute transactions with third-party providers from within a terminal window using the command line;

FIG. 2 is a simplified diagram illustrating an environment enabling users to execute transactions with third-party providers from within a terminal window using the command line;

FIG. 3 is an illustrative first screenshot of a terminal window according to a first embodiment of this disclosure;

FIG. 4 is an illustrative second screenshot of the terminal window according to the first embodiment of this disclosure;

FIG. 5 is an illustrative third screenshot of the terminal window according to the first embodiment of this disclosure;

FIG. 6 is an illustrative fourth screenshot of the terminal window according to the first embodiment of this disclosure;

FIG. 7 is an illustrative first screenshot of a terminal window according to a second embodiment of this disclosure;

FIG. 8 is an illustrative second screenshot of the terminal window according to the second embodiment of this disclosure;

FIG. 9 is an illustrative third screenshot of the terminal window according to the second embodiment of this disclosure; and

FIG. 10 is an illustrative fourth screenshot of the terminal window according to the second embodiment of this disclosure.

### DETAILED DESCRIPTION OF THE DRAWINGS

While the concepts of the present disclosure are susceptible to various modifications and alternative forms, specific embodiments thereof have been shown by way of example in the figures and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

The disclosed embodiments may be implemented, in some cases, in hardware, firmware, software, or any combination thereof. The disclosed embodiments may also be implemented as instructions carried by or stored on a transitory or non-transitory computer-readable storage medium, which may be read and executed by one or more processors. A computer-readable storage medium may be embodied as any storage device, mechanism, or other physical structure for storing or transmitting information in a form readable by a computing device (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

The presently disclosed systems and methods allow software developers to be more productive by reducing interruptions. In particular, the presently disclosed systems and methods allow software developers to remain within their primary interface (e.g., the terminal) and to leverage one syntax, as opposed to switching between multiple interfaces (terminal to email to web, etc.) with multiple different syntaxes. New users are able to create an account, set up a billing method, deploy an application and label it (with a brand new domain) without leaving the terminal window and without context switching for the user. Additionally or alternatively, an administrator is able to set up a team or organization with team billing method, thereby allowing any new member to join the team or organization and instantly get to work without need to input account details or otherwise. It should be appreciated that, in the present disclosure, the term “primary interface” refers to a user interface for developing (e.g., writing or editing) software.

To do so, a user may first log in to the program from within the terminal window by executing a command line (e.g., “now—login”). The user may then add a payment method through executing another command line (e.g., “now billing add”). The user may then run a command to make a secure purchase of, for example, a domain. The system may issue an authorization on the payment method and attempt to purchase the domain. The purchase may occur instantaneously and the system may capture the authorized amount from the payment method.

In some embodiments, where aliasing is desired, the system and methods may configure the Domain Name System (DNS) records for the domain so that any requests to the domain will reach the system's servers successfully. The aliasing process may occur without context switching for the user (e.g. the user does not need to configure DNS records, to configure nameservers, to learn about DNS or nameservers, or to setup WHOIS information). Instead, the user is able to deliver their product in a presentable fashion (with a branded domain) entirely from within the terminal window.

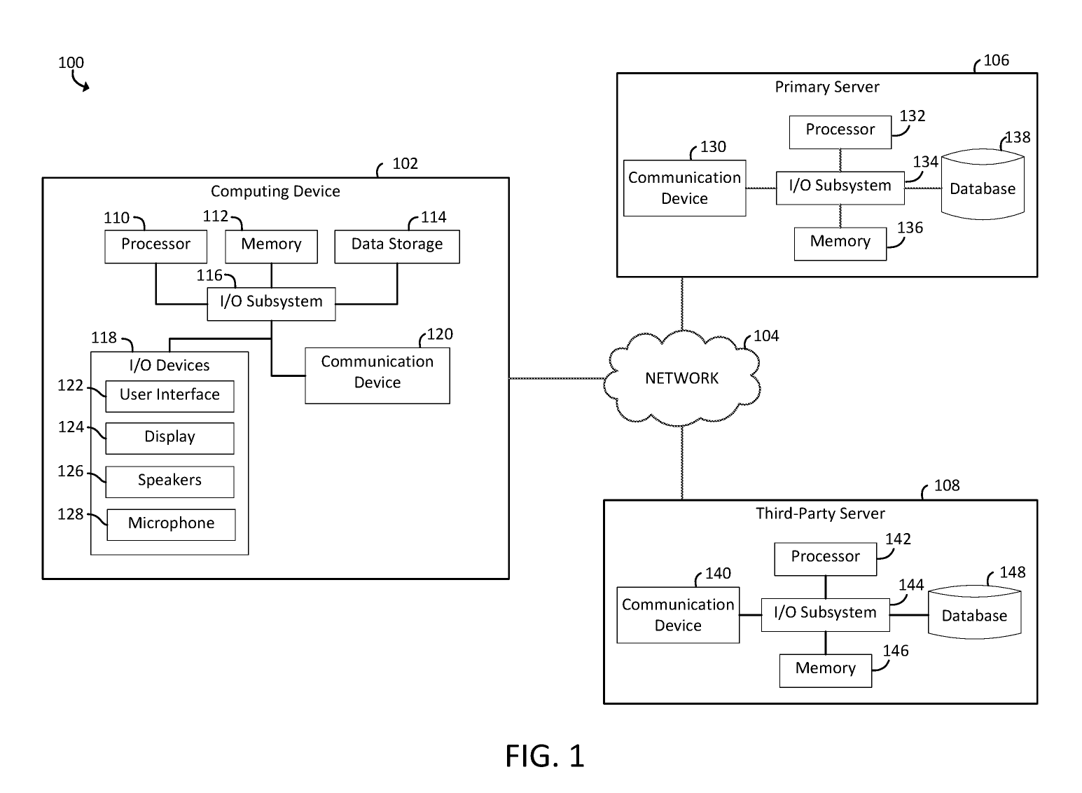

Referring now to FIG. 1, in an illustrative embodiment, a system 100 for enabling secure transactions includes a computing device 102 that is communicatively connected to each of a primary server 104 and a third-party server 106 through a network 104. Each of the computing device 102, the primary server 106, and the third-party server 108 may be connected to one another via one or more wired and/or wireless connections. While the illustrative embodiment of FIG. 1 includes one computing device 102, one primary server 106, and one third-party server 108, it should be appreciated that any number of computing devices 102, primary servers 106, and third-party servers 108 may be included in the illustrative system 100.

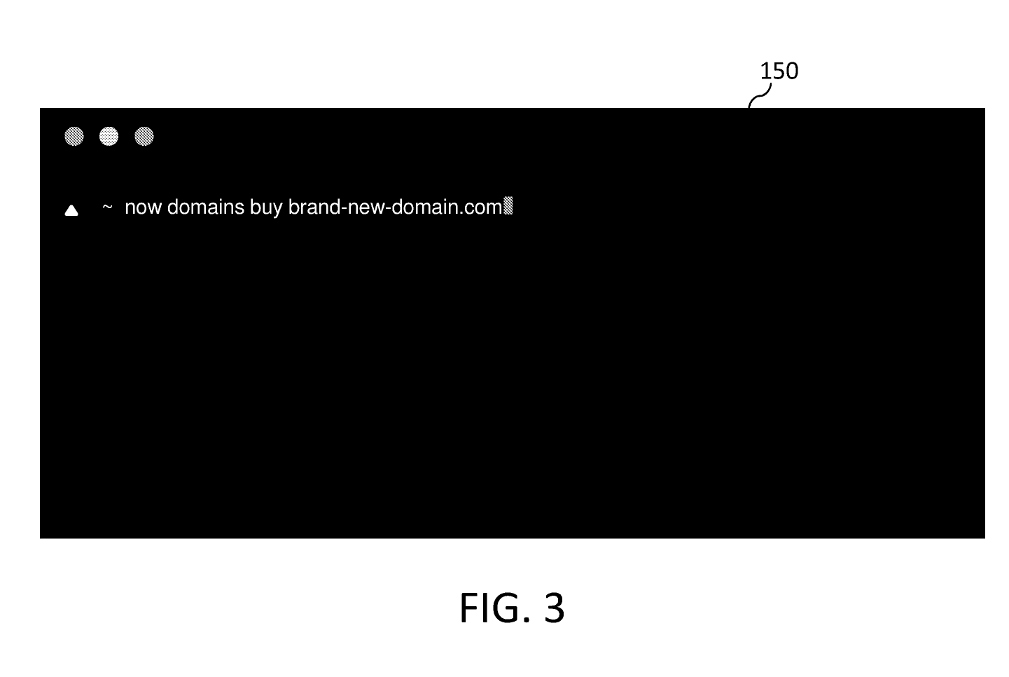

The computing device 102 is configured to be used by a user to engage in a secure transaction from within a primary interface of the computing device 102 with one or more servers 104, 106. In the illustrative embodiment, the primary interface is embodied as a terminal window 150 of the computing device 102, as shown in FIGS. 3-10. The computing device 102 may be configured to make a secure purchase from within the terminal window 150 using one or more command lines and to further enable execution of transactions with third-party providers directly within the terminal window 150. This allows for the removal of all third-party interruptions from existing software engineering workflows, and thereby shortening the lapsed time between need identification and solution implementation. The computing device 102 may be configured to communicate with the primary server 106 and the third-party server 108. The computing device 102 may communicate with the primary server 106 to establish account information. For example, the computing device 102 may communicate with the primary server 106 to create an account and to set up a billing method. The computing device 102 may also further communicate with the primary server 106 to deploy an application and label it (with a brand new domain) without leaving the terminal window 150 and without context switching for the user. The computing device 102 may send information to primary server 106 where primary server 106 may communicate with the third-party server 108 in order to perform a secure transaction.

In the illustrative embodiment, the computing device 102 includes a processor 110, a memory 112, a data storage 114, an I/O subsystem 116, I/O devices 118, and a communication device 120. The computing device 102 may be embodied as any type of computation or computer device capable of performing the functions described herein, including, without limitation, a computer, a multiprocessor system, a laptop computer, a notebook computer, a network appliance, a web appliance, a distributed computing system, a processor-based system, and/or a consumer electronic device. It should be appreciated that the computing device 102 may include other or additional components to those shown in FIG. 1, such as those commonly found in a computing device (e.g., various input/output devices), in other embodiments. Additionally, in some embodiments, one or more of the illustrative components may be incorporated in, or otherwise form a portion of, another component. For example, the memory 112, or portions thereof, may be incorporated in the processor 110 in some embodiments.

The processor 110 may be embodied as any type of processor capable of performing the functions described herein. For example, the processor 110 may be embodied as a single or multi-core processor(s), digital signal processor, microcontroller, or other processor or processing/controlling circuit. Similarly, the memory 112 may be embodied as any type of volatile or non-volatile memory or data storage capable of performing the functions described herein. In operation, the memory 112 may store various data and software used during operation of the computing device 102 such operating systems, applications, programs, libraries, and drivers. The memory 112 is communicatively coupled to the processor 110 via the I/O subsystem 116, which may be embodied as circuitry and/or components to facilitate input/output operations with the processor 110, the memory 112, and other components of the computing device 102. For example, the I/O subsystem 116 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations.

The data storage 114 may be embodied as any type of device or devices configured for short-term or long-term storage of data such as, for example memory devices and circuits, memory cards, hard disk drives, solid-state drives, or other data storage devices. The data storage 114 may store compressed and/or decompressed data processed by the computing device 102. The data storage 114 may be configured to store the information provided by the user to complete an account set up with the primary server 106. The data storage 114 may also store data to expedite the purchasing process. The data storage 114 may store libraries for the command scripts to be run by the computing device 102.

In the illustrative embodiment, the I/O devices 118 include a user interface 122, a display 124, speakers 126, and a microphone 128. As discussed below, these I/O devices 118 may be used to receive input from the user and output progress to the user in making the secure purchase through the terminal window 150. The user interface 122 may include any combination of input/output devices, such as, for example, buttons, keyboard, or a computer touchscreen. For example, the user may input account information through the user interface 122 to send to the primary server 106. The display 124 and speakers 124 may present the progress the user has achieved in making a secure purchase from within the terminal window 150 using a command line. The display 124 may also show the terminal window 150 to be implemented by the system 100. In some embodiments, the microphone 128 may further be used as an input into the terminal window 150. The microphone 128 may capture information verbally presented by the user. In another embodiment, the I/O devices 118 may include other devices to input and output information to and from the user on the computing device 102. The computing device 102 may send some or all of the information collected from the I/O devices 118 to the primary server 106.

The computing device 102 further includes a communication device 120, which may be embodied as any communication circuit, device, or collection thereof, capable of enabling communications between the computing device 102 and the primary server 106 and the third-party server 108 the network 104. The communication device 120 may be configured to use any one or more communication technology (e.g., wired or wireless communications) and associated protocols (e.g., Ethernet, Bluetooth®, Wi-Fi®, WiMAX, etc.) to effect such communication. The computing device 102 can include other peripheral devices as might be necessary to perform the functions of the computing device 102, such as displays, keyboards, other input/output devices, and other peripheral devices.

The network 104 may be embodied as any type of network capable of facilitating communications between the computing device 102 and the primary server 106 and the third-party server 108. For example, the network 104 may be embodied as, or otherwise include, a wired or wireless local area network (LAN), a wired or wireless wide area network (WAN), a cellular network, and/or a publicly-accessible, global network such as the Internet. As such, the network 104 may include any number of additional devices, such as additional computers, routers, and switches, to facilitate communications thereacross.

In the illustrative embodiment, the primary server 106 may be configured to receive input from the computing device 102 to be processed to make a secure purchase within the terminal window 150 of the computing device 102. The primary server 106 may communicate with the third-party server 108 after processing the input received from the computing device 102 in order to execute a transaction. The primary server 106 illustratively includes a communication device 130, a processor 132, an I/O subsystem 134, a memory 136, and a database 138. The primary server 106 may be embodied as any type of computation or computer device capable of performing the functions described herein, including, without limitation, a computer, a multiprocessor system, a server, a rack-mounted server, a blade server, a laptop computer, a notebook computer, a network appliance, a web appliance, a distributed computing system, a processor-based system, and/or a consumer electronic device. It should be appreciated that the primary server 106 may include other or additional components to those shown in FIG. 1, such as those commonly found in a server device (e.g., various input/output devices), in other embodiments. Additionally, in some embodiments, one or more of the illustrative components may be incorporated in, or otherwise form a portion of, another component. For example, the memory 136, or portions thereof, may be incorporated in the processor 132 in some embodiments. The various components of the primary server 106 function similarly to the similar components included in the computing device 102 as discussed above. Similarly to the data storage 114 of the computing device, the database 138 may store information received from the computing device 102.

In some embodiments, the primary server 106 may be embodied as multiple servers 106 in order to perform separate tasks, similar tasks, or a combination of separate and similar tasks. For example, there may be a different primary server 106 to receive input from the computing device 102 and process that input and another separate primary server 106 to perform the transactions and authorizing the payment of the transactions.

In some embodiments, the database 138 may store an organization structure to provide team billing for a team or organization. The computing device 102 may add or remove members to the team to utilize the team billing method and instantly get to work without the need to input account details or otherwise. The primary server 106 may communicate with the computing device 102 to facilitate modification of the organization structure.

In the illustrative embodiment, the third-party server 108 may include many of the similar components as the primary server 106. The third-party server 108 may be configured to communicate with the primary server 102 and/or the computing device 102 in order to make a secure transaction. The secure transaction may be, for example, acquiring domain names; acquiring SSL/EV certificates; automatically renewing original server certificates; and upgrading server capacity. The third-party server 108 may be configured to communicate with both of the computing device 102 and the primary server 106. The third-party server 108 illustratively includes a communication device 140, a processor 142, an I/O subsystem 144, a memory 146, and a database 148. Each of the communication device 140, processor 142, I/O subsystem 144, memory 146, and database 148 functions similarly as the similar components of the primary server 106 as described above. Each of the communication device 140, processor 142, I/O subsystem 144, memory 146, and database 148 may also be embodied similarly to the corresponding components of the primary server 106.

The third-party server 108 may be embodied as any type of computation or computer device capable of performing the functions described herein, including, without limitation, a computer, a multiprocessor system, a server, a rack-mounted server, a blade server, a laptop computer, a notebook computer, a network appliance, a web appliance, a distributed computing system, a processor-based system, and/or a consumer electronic device. It should be appreciated that the third-party server 108 may include other or additional components to those shown in FIG. 1, such as those commonly found in a server device (e.g., various input/output devices), in other embodiments. Additionally, in some embodiments, one or more of the illustrative components may be incorporated in, or otherwise form a portion of, another component. For example, the memory 146, or portions thereof, may be incorporated in the processor 142 in some embodiments.

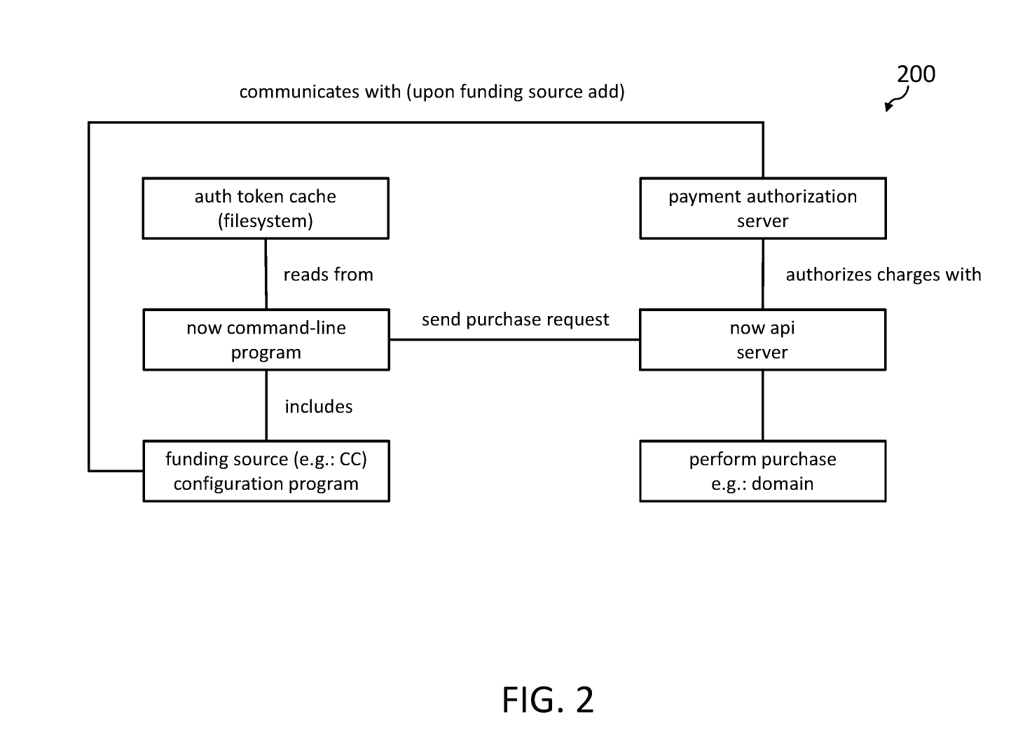

Referring now to FIG. 2, in the illustrative embodiment, the system 100 may establish an environment 200 during operation to enable users to execute transactions with third-party providers from within a terminal window 150 using one or more command lines (i.e., using syntax of the terminal window). The illustrative environment 200 includes an authentication token cache (filesystem) that reads from a “now” command-line program. The now command-line program includes a funding source (e.g., credit card information) configuration program that communicates with a payment authorization server in response to a funding source being added. In response to user execution of the now command-line program (further discussed below), the now command-line program sends a purchase request to a now API server 106. The payment authorization server 108 is configured to authorize charges with the now API server 106 to perform the commanded purchase (e.g. of a domain).

Referring now to FIGS. 3-6, four illustrative screenshots of a terminal window 150 of a computing device are shown to illustrate one embodiment of a method enabling a user to execute a secure transaction with a third-party provider from within the terminal window 150 using syntax of the terminal window. As shown in FIG. 3, in the illustrative embodiment, a user begins the method by calling a “now” command-line program to attempt to purchase a particular domain. To do so, for example, the user may type “now domains buy” followed by the particular domain name (e.g., “brand-new-domain.com” in FIG. 3) that the user seeks to purchase.

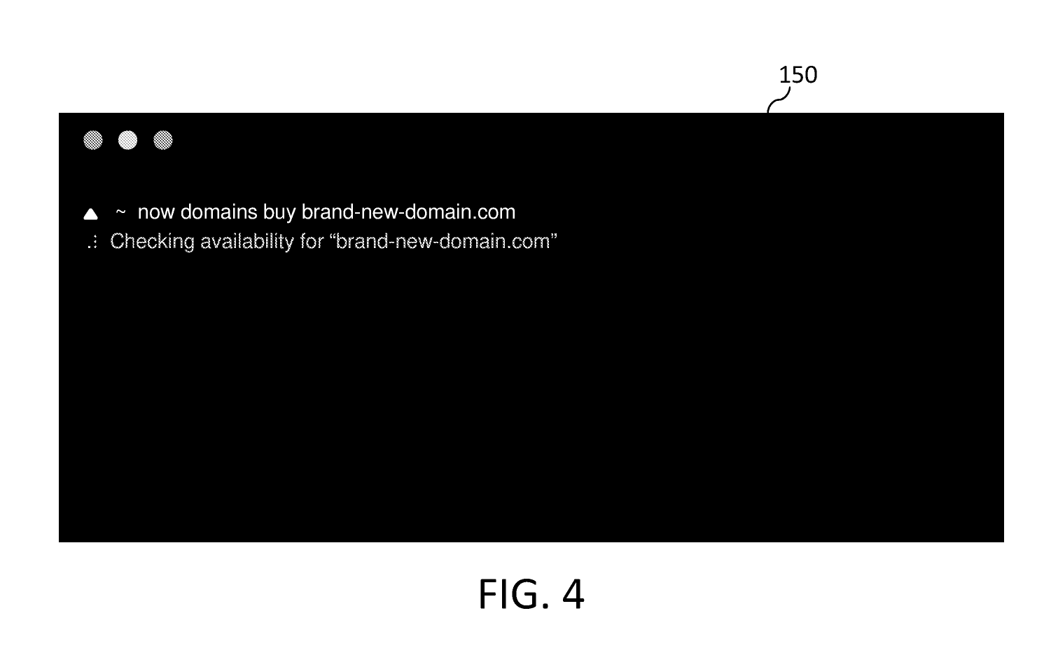

As shown in FIG. 4, in response to the user executing the command script shown in FIG. 3, the now command-line program, in conjunction with the now API server 106, checks the availability of the particular domain name sought by the user. As illustrated in FIG. 4, the now command-line program provides a visual indicator to the user that this availability check is being performed.

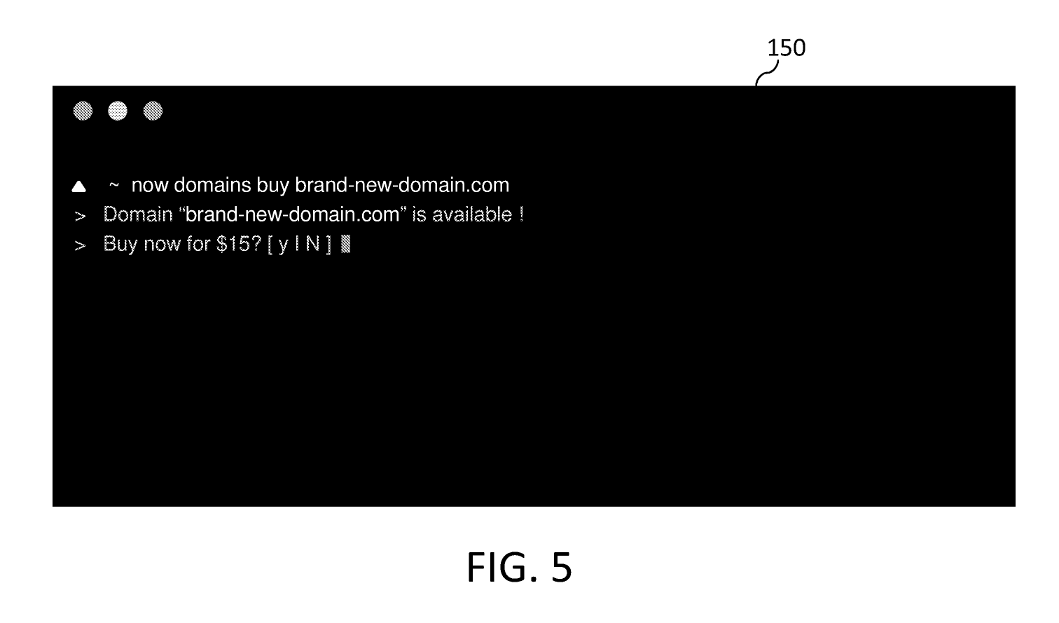

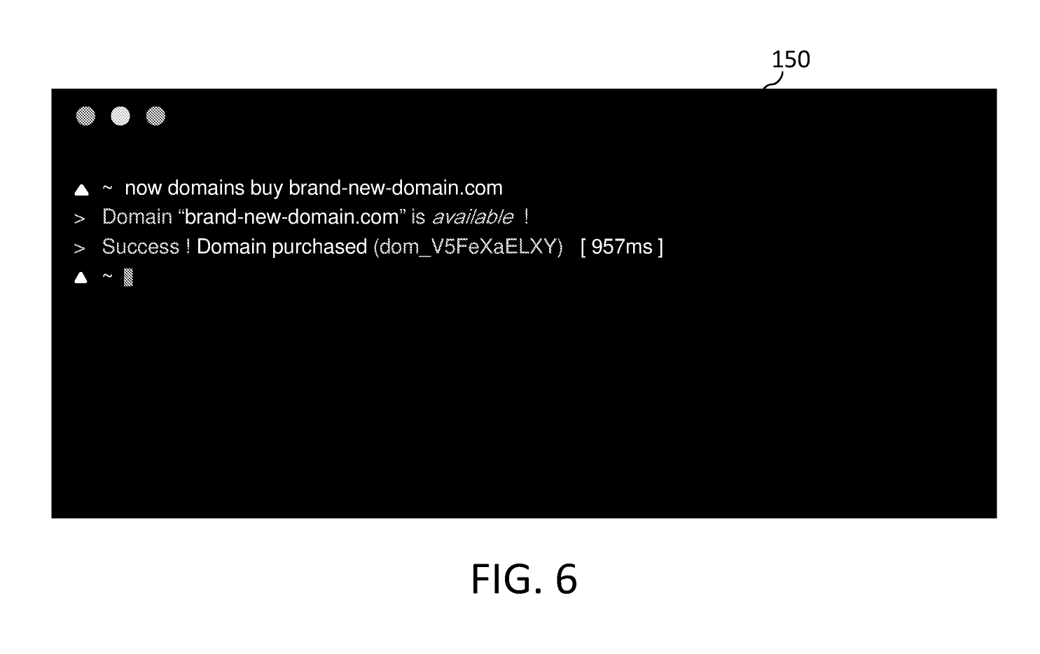

As shown in FIG. 5, in response to a determination that the particular domain name sought by the user is available for purchase, the now command-line program notifies the user that the particular domain name is available. Additionally, the now command-line program provides an indication of the purchase price of the domain name and queries the user whether to execute the transaction. In response to receiving an indication from the user that the user wants to execute the transaction, the now command-line program sends instructions to the now API server 106 to execute the transaction with the domain server 108. As shown in FIG. 6, upon successful completion of the purchase, the now command-line program provides an indication to the user of this successful completion.

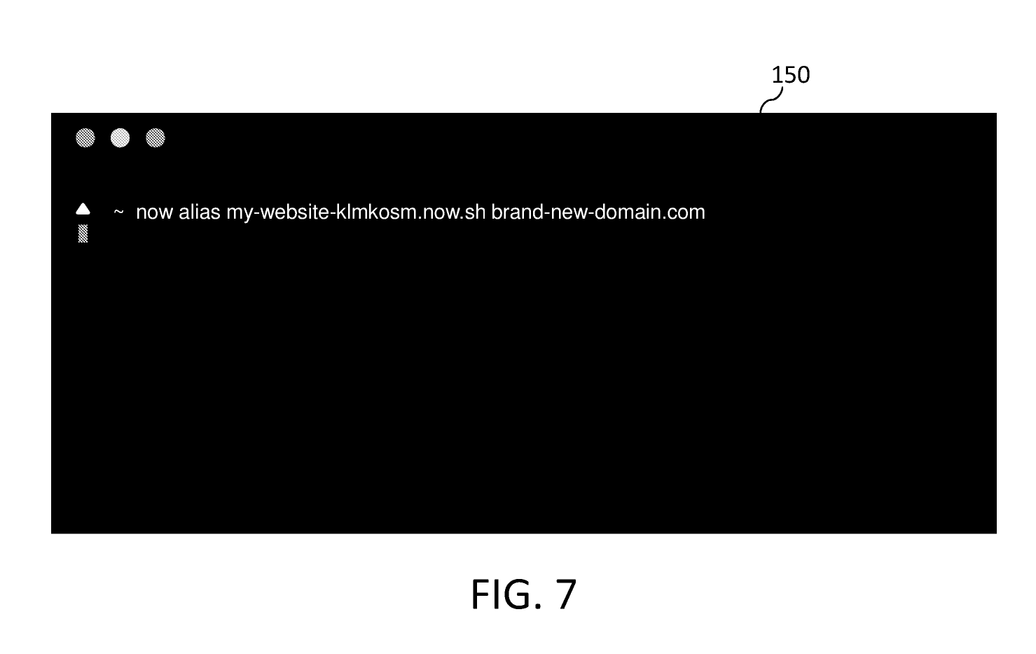

Referring now to FIGS. 7-10, four illustrative screenshots of a terminal window 150 of a computing device are shown to illustrate another embodiment of a method enabling a user to execute a secure transaction with a third-party provider from within the terminal window 150 using the command line. In this embodiment, the now command-line program is utilized for aliasing of a domain name. As shown in FIG. 7, a user begins the method by calling the “now” command-line program to attempt to alias a particular domain. To do so, for example, the user may type “now alias” followed by the particular domain name to be aliased (e.g., “my-website-klmkosm.now.sh” in FIG. 7) and then the alias domain name (e.g., “brand-new-domain.com” in FIG. 7).

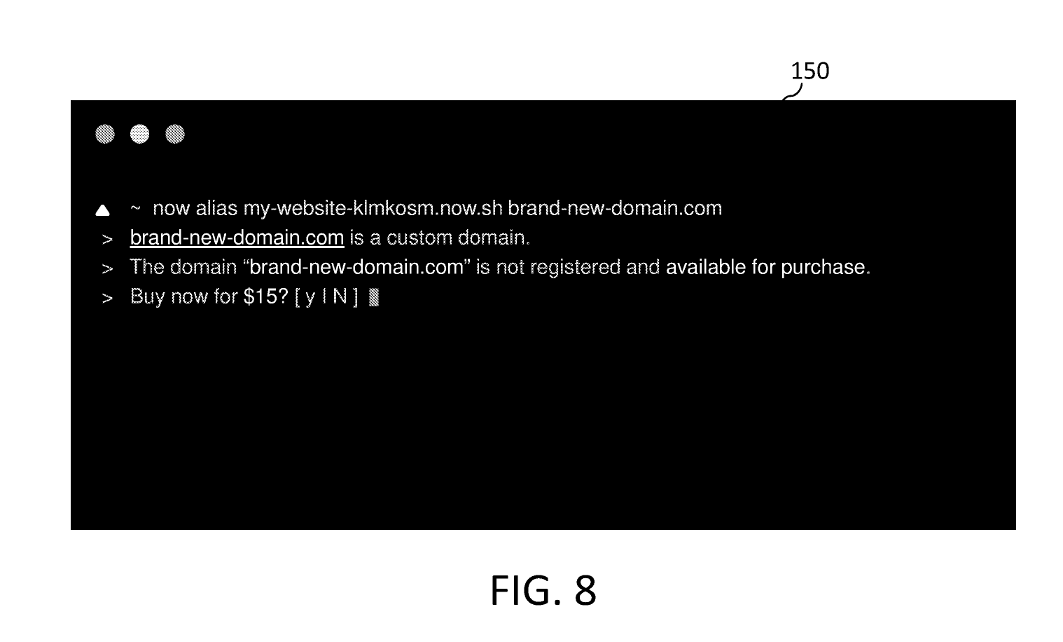

As shown in FIG. 8, in response to the user executing the command script shown in FIG. 7, the now command-line program, in conjunction with the now API server 106, checks the availability of the alias domain name sought by the user. In response to a determination that the alias domain name sought by the user is available for purchase, the now command-line program provides the user with a notification of this availability. Additionally, the now command-line program provides an indication of the purchase price of the alias domain name and queries the user as to whether they wish to execute the transaction.

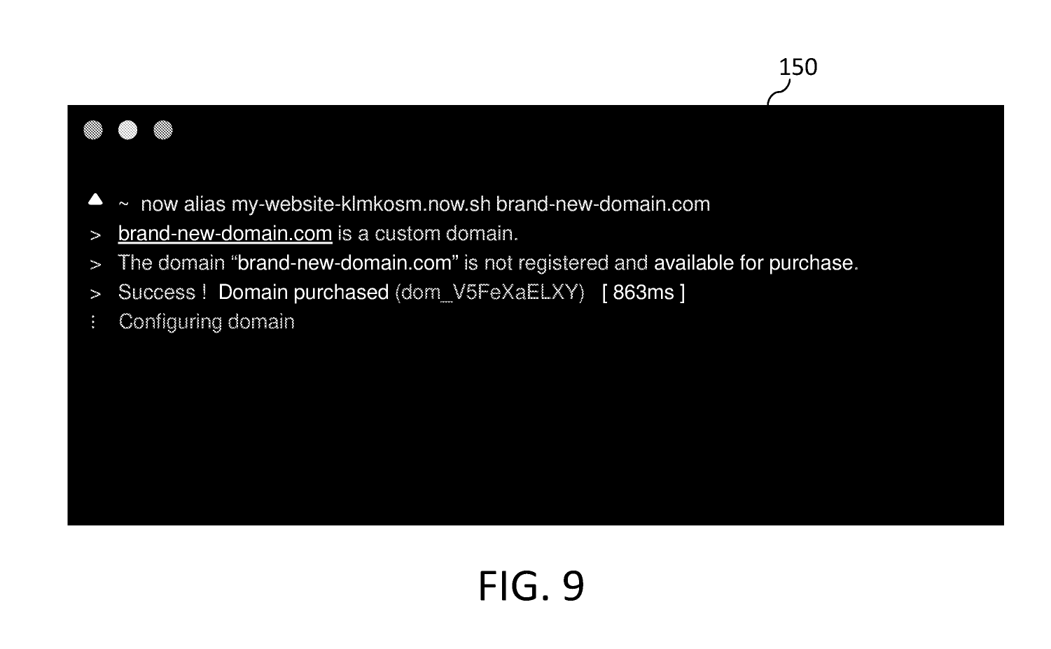

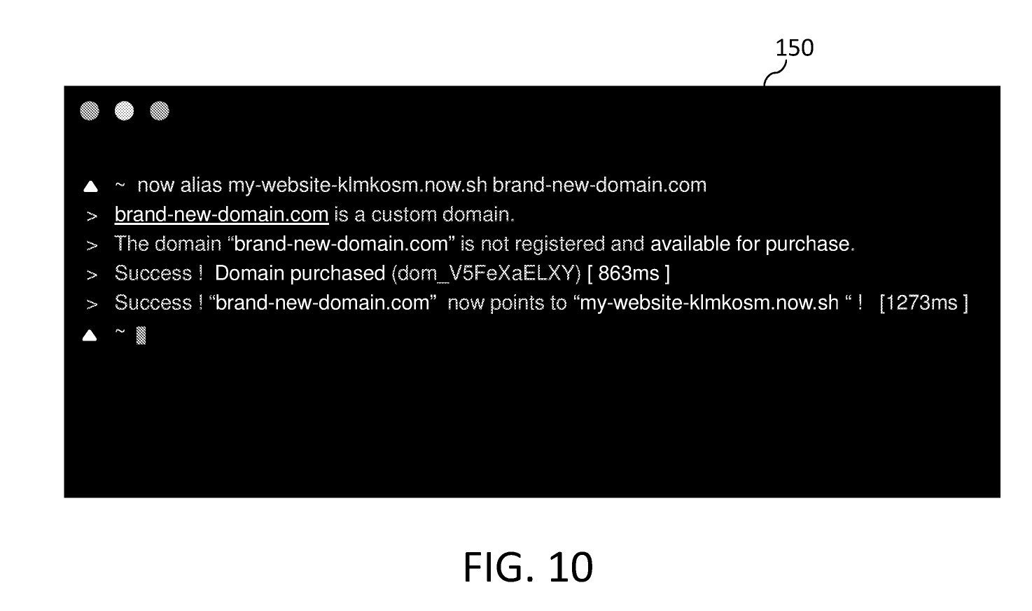

In response to receiving an indication from the user that the user wants to execute the transaction, the now command-line program sends instructions to the now API server 106 to execute the transaction with the domain server 108. As shown in FIG. 9, upon successful completion of the purchase, the now command-line program provides an indication to the user of this successful completion. The system will then automatically configure the DNS records for the alias domain so that any requests to the domain will reach the aliased domain successfully. Additionally, the now command-line program further provides an indication to the user that the configuration is being performed. As shown in FIG. 10, upon successful completion of the configuration, the now command-line program provides an appropriate notification to the user (e.g., “Success! “brand-new-domain.com” now points to “my-website-klmkosm.now.sh”!).

It should be appreciated that the one of ordinary skilled in the art would understand that the commands illustrated in FIGS. 3-10 are exemplary and that other commands may be used to enable the secure transactions.

While certain illustrative embodiments have been described in detail in the figures and the foregoing description, such an illustration and description is to be considered as exemplary and not restrictive in character, it being understood that only illustrative embodiments have been shown and described and that all changes and modifications that come within the spirit of the disclosure are desired to be protected. There exist a plurality of advantages of the present disclosure arising from the various features of the apparatus, systems, and methods described herein. It will be noted that alternative embodiments of the apparatus, systems, and methods of the present disclosure may not include all of the features described, yet still benefit from at least some of the advantages of such features. Those of ordinary skill in the art may readily devise their own implementations of the apparatus, systems, and methods that incorporate one or more of the features of the present disclosure.

1. A method for enabling a secure transaction from within a primary interface of a computing device, the method comprising:
receiving, by the primary interface, a user input from a user indicating a domain name of interest in a syntax of the primary interface;
transmitting, by the computing device, a first command to a server to cause the server to determine an availability of the domain name;
receiving, by the computing device, an indication of the availability of the domain name from the server;
generating, by the primary interface, in response to an indication from the server that the domain name is available, a user prompt to query whether the domain name should be purchased in the syntax of the primary interface;
receiving, by the primary interface, a user input indicating that the domain name should be purchased in the syntax of the primary interface; and
transmitting, by the computing device, a second command to the server to cause the server to purchase the domain name.

2. The method of claim 1, wherein the primary interface is a terminal window of the computing device.

3. The method of claim 1, wherein transmitting the first and/or second commands to the server causes the server to determine whether the user input is associated with an existing user account and to create, in response to a determination that the user input is not associated with an existing user account, a new user account.

4. The method of claim 3, further comprising:
receiving, by the computing device, an indication from the server that the new user account has been created; and
generating, by the primary interface, in response to the indication from the server that the new user account has been created, a user prompt to set up a billing method which is to be used to purchase the domain name in the syntax of the primary interface.

5. The method of claim 3, wherein transmitting the first and/or second commands to the server further causes the server to determine, in response to the creation of the new user account, whether the new user account belongs to an existing group having an existing billing method.

6. The method of claim 5, further comprising:
receiving, by the computing device, an indication from the server that the new user account does not belong to an existing group; and
generating, by the primary interface, in response to the indication from the server that the new user account does not belong to an existing group, a user prompt to set up a billing method which is to be used to purchase the domain name in the syntax of the primary interface.

7. The method of claim 1, wherein transmitting the first and/or second commands to the server causes the server to determine whether the user input is associated with an existing user account and to retrieve, in response to a determination that the user input is associated with an existing user account, an existing billing method that is to be used to purchase the domain name.

8. The method of claim 1, further comprising deploying an application to the domain name from the primary interface using the syntax of the primary interface.

9. A method for enabling a secure transaction from within a primary interface of a computing device, the method comprising:
receiving, by the primary interface, an aliasing request in a syntax of the primary interface, the aliasing request including an existing domain name and a new domain name that is to alias the existing domain name;
transmitting, by the computing device, a first command to a server to cause the server to determine whether the new domain name is registered and to determine, in response to a determination that the new domain name is not registered, an availability of the new domain name;
receiving, by the computing device, an indication of the availability of the new domain name from the server;
generating, by the primary interface, in response to an indication from the server that the new domain name is available, a user prompt to query whether the new domain name should be purchased in the syntax of the primary interface;
receiving, by the primary interface, a user input indicating that the new domain name should be purchased in the syntax of the primary interface; and
transmitting, by the computing device, a second command to the server to cause the server to purchase the new domain name and to alias the existing domain name with the new domain name.

10. The method of claim 9, wherein the primary interface is a terminal window of the computing device.

11. The method of claim 9, wherein transmitting the first and/or second commands to the server causes the server to determine whether the user input is associated with an existing user account and to create, in response to a determination that the user input is not associated with an existing user account, a new user account.

12. The method of claim 11, further comprising:
receiving, by the computing device, an indication from the server that the new user account has been created; and
generating, by the primary interface, in response to the indication from the server that the new user account has been created, a user prompt to set up a billing method which is to be used to purchase the domain name in the syntax of the primary interface.

13. The method of claim 11, wherein transmitting the first and/or second commands to the server further causes the server to determine, in response to the creation of the new user account, whether the new user account belongs to an existing group having an existing billing method.

14. The method of claim 13, further comprising:
receiving, by the computing device, an indication from the server that the new user account does not belong to an existing group; and
generating, by the primary interface, in response to the indication from the server that the new user account does not belong to an existing group, a user prompt to set up a billing method which is to be used to purchase the domain name in the syntax of the primary interface.

15. The method of claim 9, wherein transmitting the first and/or second commands to the server causes the server to determine whether the user input is associated with an existing user account and to retrieve, in response to a determination that the user input is associated with an existing user account, an existing billing method that is to be used to purchase the domain name.

16. A computing device comprising:
a primary interface configured to:
receive a user input indicating a domain name of interest in a syntax of the primary interface;
cause the computing device to transmit a first command to a server to cause the server to determine an availability of the domain name;
receive an indication of the availability of the domain name from the server;
generate, in response to a determination that the domain name is available, a user prompt to query whether the domain name should be purchased in the syntax of the primary interface;
receive a user input indicating that the domain name should be purchased in the syntax of the primary interface; and
cause the computing device to transmit a second command to the server to cause the server to purchase the domain name.

17. The computing device of claim 16, wherein the primary interface is a terminal window of the computing device.

18. The computing device of claim 16, wherein the primary interface is further configured to deploy an application to the domain name from the primary interface using the syntax of the primary interface.

19. The computing device of claim 16, wherein the primary interface is further configured to receive a user input indicating a billing method to be used to purchase the domain name and to cause the computing device to transmit the billing method to the server.

20. The computing device of claim 19, wherein the second command causes the server to purchase the domain name using the billing method.
